(19) United States
(12) Patent Application Publication
(10) Pub. No.: US 2020/0167812 A1
(43) Pub. Date: May 28, 2020

(54) SYSTEMS AND METHODS FOR DETERMINING A FEE OF A SERVICE REQUEST

(71) Applicant: BEIJING DIDI INFINITY TECHNOLOGY AND DEVELOPMENT CO., LTD., Beijing (CN)

(72) Inventors: Yifei ZHANG, Beijing (CN); Hengzhi WANG, Beijing (CN); Licai QI, Beijing (CN)

(73) Assignee: BEIJING DIDI INFINITY TECHNOLOGY AND DEVELOPMENT CO., LTD., Beijing (CN)

(21) Appl. No.: 16/749,951

(22) Filed: Jan. 22, 2020

Related U.S. Application Data
(63) Continuation of application No. PCT/CN2017/095070, filed on Jul. 28, 2017.

(51) Int. Cl. G06Q 30/02; G06N 5/04

(52) U.S. Cl. CPC G06Q 30/0206; G06N 5/04; G06Q 30/0202

(57) ABSTRACT

The present disclosure relates to systems and methods for determining a fee of a service request in an on-demand transportation service. The systems may perform the methods to receive a service request from a terminal; determine an estimated basic fee of the service request; generate an estimated adjusting rate of fee corresponding to the estimated conversion rate of transaction; generate an estimated conversion rate of transaction associated with the service request by a prediction model; obtain a function value of a target function, wherein the target function relates to the estimated basic fee, the estimated conversion rate of transaction, and the estimated adjusting rate of fee; and determine an optimized adjusting rate of fee by repeating one or more steps above and comparing the function values, wherein the optimized adjusting rate of fee maximizes the function value of the target function.

### CROSS-REFERENCE TO RELATED APPLICATIONS

This application is a continuation of International Application No. PCT/CN2017/095070, filed on Jul. 28, 2017, designating the United States of America, the entire contents of which is expressly incorporated herein.

### TECHNICAL FIELD

The present disclosure generally relates to systems and methods for on-demand services, and in particular, systems and methods for determining a fee of a service request in an on-demand transportation service.

### BACKGROUND

Internet based on-demand transportation services, such as online taxi-calling services, have become increasingly popular because of the convenience of using the services. A system providing an on-demand transportation service may balance demand of the service requesters and supply of the service providers. The system may adjust a fee of the service request dynamically. However, the system should take the interests of all parties into consideration while adjusting the fee of the service request and provide optimal results.

### SUMMARY

According to a first aspect of the present disclosure, a system is provided. The system may include at least one storage medium including a set of instructions for determining a fee of a service request in an on-demand service and at least one processor configured to communicate with the at least one storage medium. In some embodiments, when executing the set of instructions, the at least one processor may be directed to (a) receive a service request from a terminal, (b) determine an estimated basic fee of the service request, (c) generate an estimated adjusting rate of fee for the service request, (d) generate an estimated conversion rate of transaction associated with the service request based on the estimated adjusting rate of fee with a prediction model, (e) obtain a function value of a target function, wherein the target function relates to the estimated basic fee, the estimated conversion rate of transaction, and the estimated adjusting rate of fee, and (f) determine an optimized adjusting rate of fee by repeating steps (c)-(e) and comparing the function values. In some embodiments, the optimized adjusting rate of fee may maximize the function value of the target function.

In some embodiments, the target function may be for calculation of gross merchandise volume (GMV) by multiplying the estimated basic fee of the service request, the estimated adjusting rate of fee associated with the service request, and the estimated conversion rate of transaction associated with the service request together.

In some embodiments, to determine the estimated basic fee of the service request, the at least one processor may be further directed to determine at least one route associated with the service request, determine a target route from the at least one route, and determine the estimated basic fee of the service request based on the target route.

In some embodiments, to determine the estimated conversion rate of transaction associated with the service request based on the estimated adjusting rate with the prediction model, the at least one processor may be further directed to obtain a plurality of example service orders, designate each of the plurality of example service orders with one of one or more labels, extract one or more features from the plurality of example service orders, train the prediction model based on the one or more features and the plurality of designated example service orders, and determine the estimated conversion rate of transaction associated with the service request based on the estimated adjusting rate with the trained prediction model. In some embodiments, the service request may also include the one or more features.

In some embodiments, the one or more features may include at least one of basic characteristics of the service request, real-time characteristics of the service request, and historical characteristics of a service order.

In some embodiments, to determine the optimized adjusting rate of fee based on the target function, the at least one processor may be directed to obtain one or more estimated adjusting rates of fee and one or more corresponding estimated conversion rates of transaction, obtain one or more function values based on the target function by utilizing the one or more estimated adjusting rates of fee and the one or more corresponding estimated conversion rates of transaction, obtain maximum function value by comparing the one or more function values, and determine the optimized adjusting rate of fee as the estimated adjusting rate that corresponds to the maximum function value.

In some embodiments, to determine the optimized adjusting rate of fee by repeating steps (c)-(e) and comparing the function values, the at least one processor may be directed to (1) determine a maximum function value and a maximum iteration number; (2) conduct steps (c)-(e) to obtain the estimated adjusting rate of fee for the service request, the estimated conversion rate of transaction associated with the service request, and the function value of the target function; (3) determine that the function value is greater than the maximum function value; (4) designate the function value to the maximum function value; (5) repeat steps (2)-(4) till meets the maximum iteration number; and (6) determine the optimized adjusting rate of fee as the estimated adjusting rate of fee that corresponds to the maximum function value.

In some embodiments, the estimated adjusting rate of fee associated with the service request may be restricted by a first threshold, or the estimated conversion rate of transaction associated with the service request is restricted by a second threshold.

In some embodiments, the estimated adjusting rate of fee may be selected from a limited number of preset values.

In some embodiments, to determine the optimized adjusting rate of fee by repeating steps (c)-(e) and comparing the function values, the at least one processor may be directed to repeat steps (c)-(e) for a limited number of times, and conduct step (f) to determine the optimized adjusting rate of fee as the estimated adjusting rate of fee that maximize a function value of the target function. In some embodiments, each time in step (c), the at least one processor may reset the estimated adjusting rate of fee to a new value from the limited number of preset values. In some embodiments, each time in step (d), the at least one processor may generate the estimated conversion rate of transaction based on the estimated adjusting rate of fee. In some embodiments, each time in step (e), the at least one processor may obtain the function value of a target function.

According to a second aspect of the present disclosure, a method is provided. The method may include (a) receiving a service request from a terminal, (b) determining an estimated basic fee of the service request, (c) generating an estimated adjusting rate of fee for the service request corresponding to the estimated conversion rate of transaction, (d) generating an estimated conversion rate of transaction associated with the service request based on the estimated adjusting rate of fee with a prediction model, (e) obtaining a function value of a target function, wherein the target function relates to the estimated basic fee, the estimated conversion rate of transaction, and the estimated adjusting rate of fee, and (f) determining an optimized adjusting rate of fee by repeating steps (c)-(e) and comparing the function values. In some embodiments, the optimized adjusting rate of fee may maximize the function value of the target function.

In some embodiments, the target function may be for calculation of gross merchandise volume (GMV) by multiplying the estimated basic fee of the service request, the estimated adjusting rate of fee associated with the service request, and the estimated conversion rate of transaction associated with the service request together.

In some embodiments, the determining the estimated basic fee of the service request may further include determining at least one route associated with the service request, determining a target route from the at least one route, and determining the estimated basic fee of the service request based on the target route.

In some embodiments, the determining the estimated conversion rate of transaction associated with the service request based on the estimated adjusting rate with the prediction model may further include obtaining a plurality of example service orders, designating each of the plurality of example service orders with one of one or more labels; extracting one or more features from the plurality of example service orders, training the prediction model based on the one or more features and the plurality of designated example service orders, and determining the estimated conversion rate of transaction associated with the service request based on the estimated adjusting rate with the trained prediction model. In some embodiments, the service request may also include the one or more features;

In some embodiments, the one or more features may include at least one of basic characteristics of the service request, real-time characteristics of the service request, and historical characteristics of a service order.

In some embodiments, the determining the optimized adjusting rate of fee by repeating steps (c)-(e) and comparing the function values include obtaining one or more estimated adjusting rates of fee and one or more corresponding estimated conversion rate of transaction, obtaining one or more function values based on the target function by utilizing the one or more estimated adjusting rates of fee and the one or more corresponding estimated conversion rates of transaction, obtaining a maximum function value by comparing the one or more function values, and determining the optimized adjusting rate of fee as the estimated adjusting rate that corresponds to the maximum function value.

In some embodiments, the determining the optimized adjusting rate of fee by repeating steps (c)-(e) and comparing the function values further include (1) determining a maximum function value and a maximum iteration number; (2) conducting steps (c)-(e) to obtain the estimated adjusting rate of fee for the service request, the estimated conversion rate of transaction associated with the service request, and the function value of the target function; (3) determining that the function value is greater than the maximum function value; (4) designating the function value to the maximum function value; (5) repeating steps (2)-(4) till meets the maximum iteration number; and (6) determining the optimized adjusting rate of fee as the estimated adjusting rate of fee that corresponds to the maximum function value.

In some embodiments, the estimated adjusting rate of fee associated with the service request may be restricted by a first threshold, or the estimated conversion rate of transaction associated with the service request is restricted by a second threshold.

In some embodiments, the estimated adjusting rate of fee may be selected from a limited number of preset values.

According to a third aspect of the present disclosure, a non-transitory computer readable medium is provided. The non-transitory computer readable medium may be embodying a computer program product, and the computer program product may comprises instructions configured to cause a computing device to (a) receive a service request from a terminal, (b) determine an estimated basic fee of the service request, (c) generate an estimated adjusting rate of fee for the service request, (d) generate an estimated conversion rate of transaction associated with the service request based on the estimated adjusting rate of fee with a prediction model, (e) obtain a function value of a target function, wherein the target function relates to the estimated basic fee, the estimated conversion rate of transaction, and the estimated adjusting rate of fee, and (f) determine an optimized adjusting rate of fee by repeating steps (c)-(e) and comparing the function values. In some embodiments, the optimized adjusting rate of fee may maximize the function value of the target function.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram of an exemplary on-demand service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary mobile device on which the terminal may be implemented according to some embodiments of the present disclosure

FIG. 4 is a block diagram illustrating an exemplary processing engine according to some embodiments of the present disclosure;

FIG. 5 is a flowchart illustrating an exemplary process for determining a fee of a service request according to some embodiments of the present disclosure;

FIG. 6 is a flowchart illustrating an exemplary process for determining an estimated conversion rate of transaction of a service request with a prediction model according to some embodiments of the present disclosure;

FIG. 7 is a flowchart illustrating an exemplary process for determining an optimized adjusting rate of fee based on a target function according to some embodiments of the present disclosure; and

FIG. 8 is a flowchart illustrating an exemplary process for determining an optimized adjusting rate of fee based on target function according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purposes of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purposes of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the systems and methods in the present disclosure are described primarily regarding an on-demand service, it should also be understood that this is only one exemplary embodiment. The systems or methods of the present disclosure may be applied to any other kind of on demand service. For example, the systems or methods of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the systems or methods of the present disclosure may include a web page, a plug-in of a browser, a client terminal, a custom system, an internal analysis system, an artificial intelligence robot, or the like, or any combination thereof.

The term “passenger,” “requestor,” “service requestor,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably. In some embodiments, “requestor” and “requestor terminal” may be used interchangeably, and “provider” and “provider terminal” may be used interchangeably.

The term “service request” and “service order” in the present disclosure are used interchangeably to refer to a request that may be initiated by a passenger, a requestor, a service requestor, a customer, a driver, a provider, a service provider, a supplier, or the like, or any combination thereof. The service request may be accepted by any one of a passenger, a requestor, a service requestor, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for determining a fee of a service request (e.g., an on-demand transportation service). The systems and methods may receive a service request from a terminal. The systems and methods may determine an estimated basic fee of the service request. The systems and methods may also generate an estimated conversion rate of transaction associated with the service request with a prediction model. The systems and methods may also generate an estimated adjusting rate of fee for the service request corresponding to the estimated conversion rate of transaction. The systems and methods may further determine an optimized adjusting rate of fee based on a target function, wherein the target function relates to the estimated basic fee, the estimated conversion rate of transaction, and the estimated adjusting rate of fee. The systems and methods according to the present disclosure may dynamically adjust a fee of the service request and optimize interests of all parties. Accordingly, the present disclosure improves the quality of services via efficiently adjusting the fee of the service request.

It should be noted that online on-demand transportation service, such as online taxi-hailing including taxi hailing combination services, is a new form of service rooted only in post-Internet era. It provides technical solutions to users and service providers that could raise only in post-Internet era. In pre-Internet era, when a user hails a taxi on the street, the taxi request and acceptance occur only between the passenger and one taxi driver that sees the passenger. If the passenger hails a taxi through a telephone call, the service request and acceptance may occur only between the passenger and one service provider (e.g., one taxi company or agent). Online taxi, however, allows a user of the service to real-time and automatically distribute a service request to a vast number of individual service providers (e.g., taxi) distance away from the user. It also allows a plurality of service providers to respond to the service request simultaneously and in real-time. Therefore, through the Internet, the online on-demand transportation systems may provide a much more efficient transaction platform for the users and the service providers that may never meet in a traditional pre-Internet transportation service system.

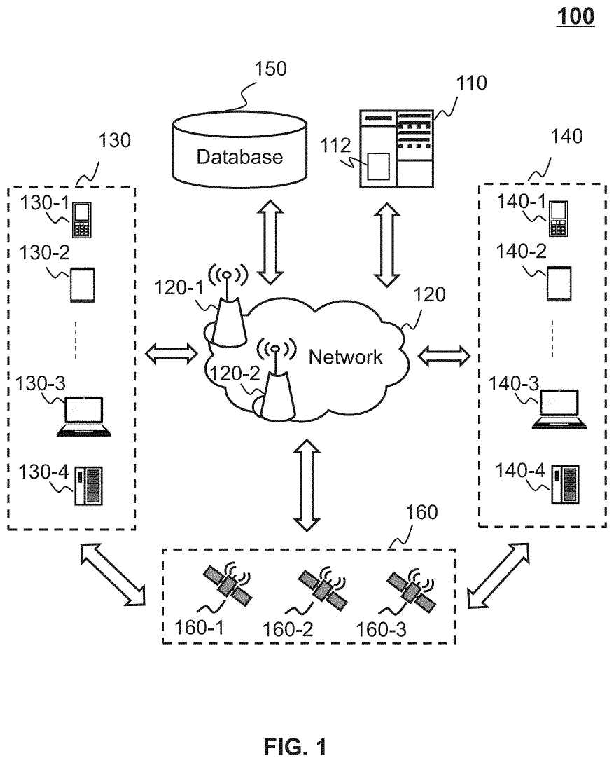

FIG. 1 is a schematic diagram of an exemplary on-demand service system 100 according to some embodiments of the present disclosure. For example, the on-demand service system 100 may be an online transportation service platform for transportation services such as taxi hailing, chauffeur services, delivery vehicles, carpool, bus service, driver hiring, and shuttle services. The on-demand service system 100 may be an online platform including a server 110, a network 120, a requestor terminal 130, a provider terminal 140, a database 150, and a positioning system 160. The server 110 may include a processing engine 112.

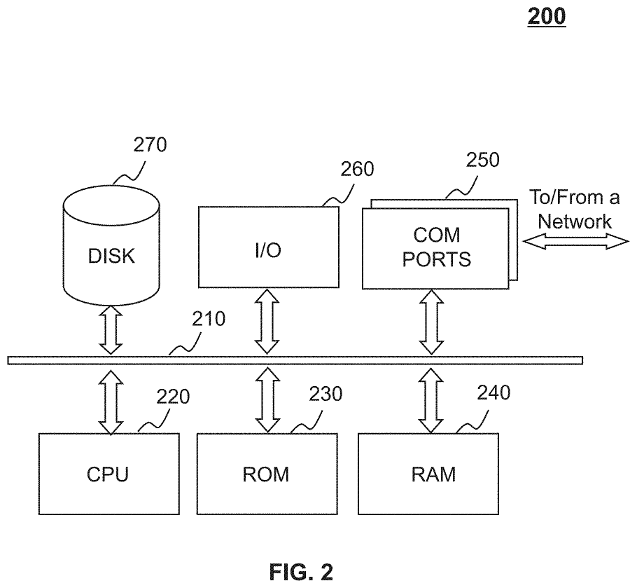

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more hardware and/or software components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine a reference parameter and an actual parameter associated with the service request obtained from the requestor terminal 130. In some embodiments, the processing engine 112 may include one or more processing engines (e.g., single-core processing engine(s) or multi-core processor(s)). Merely by way of example, the processing engine 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components in the on-demand service system 100 (e.g., the server 110, the requestor terminal 130, the provider terminal 140, the database 150, and the positioning system 160) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or a combination thereof. Merely by way of example, the network 130 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may use the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be a device that is similar to, or the same as the requestor terminal 130. In some embodiments, the provider terminal 140 may be a device utilizing positioning technology for locating the position of a user of the provider terminal 140 (e.g., a service provider) and/or the provider terminal 140. In some embodiments, the requestor terminal 130 and/or the provider terminal 140 may communicate with one or more other positioning devices to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, the database 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140), One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140). In some embodiments, the database 150 may be part of the server 110.

The positioning system 160 may determine information associated with an object, for example, one or more of the requestor terminal 130, the provider terminal 140, etc. The information may include a location, an elevation, a velocity, or an acceleration of the object, or a current time. For example, the positioning system 160 may determine a current location of the requestor terminal 130. In some embodiments, the positioning system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The location may be in the form of coordinates, such as, latitude coordinate and longitude coordinate, etc. The positioning system 160 may include one or more satellites, for example, a satellite 160-1, a satellite 160-2, and a satellite 160-3. The satellites 160-1 through 160-3 may determine the information mentioned above independently or jointly. The satellite positioning system 160 may send the information mentioned above to the network 120, the requestor terminal 130, or the provider terminal 140 via wireless connections.

In some embodiments, one or more components in the on-demand service system 100 (e.g., the server 110, the requestor terminal 130, the provider terminal 140) may have permission to access the database 150. In some embodiments, one or more components in the on-demand service system 100 may read and/or modify information relating to the requestor, provider, and/or the public when one or more conditions are met. For example, the server 110 may read and/or modify one or more users' information after a service is completed. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle), a car (e.g., a taxi, a bus, a private car), a train, a subway, a vessel, an aircraft (e.g., an airplane, a helicopter, a space shuttle, a rocket, a hot-air balloon), or the like, or any combination thereof.

FIG. 2 is a schematic diagram illustrating exemplary hardware and software components of a computing device 200 on which the server 110, the requester terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general-purpose computer or a special-purpose computer; both may be used to implement an on-demand service system 100 for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or any other type of non-transitory storage medium to be executed by the CPU 220. The methods and/or processes of the present disclosure may be implemented as the program instructions. The computing device 200 also includes an I/O component 260, supporting input/output between the computer and other components therein. The computing device 200 may also receive programming and data via network communications.

Merely for illustration, only one CPU and/or processor is illustrated in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU 220 or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

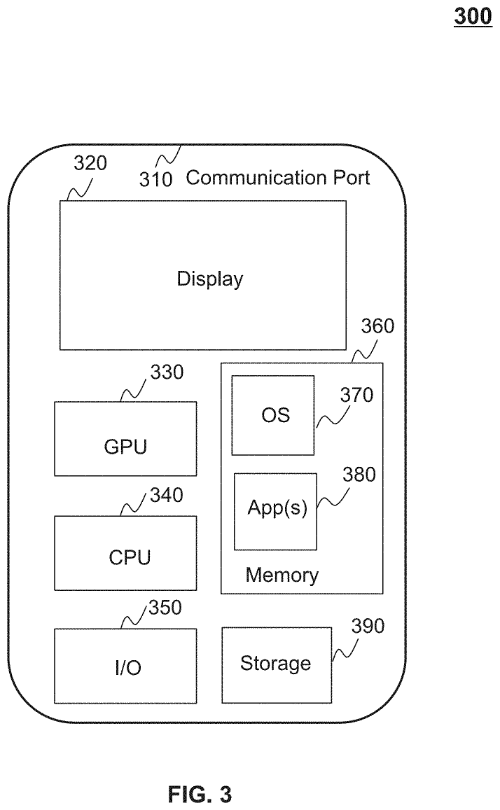

FIG. 3 is a schematic diagram illustrating exemplary hardware and/or software components of an exemplary mobile device 300 on which the terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to determining a fee of a service request or other information from, for example, the data transmission device 120. User interactions with the information stream may be achieved via the I/O 350 and provided to the server 110 and/or other components of the on-demand service system 100 via the network 120.

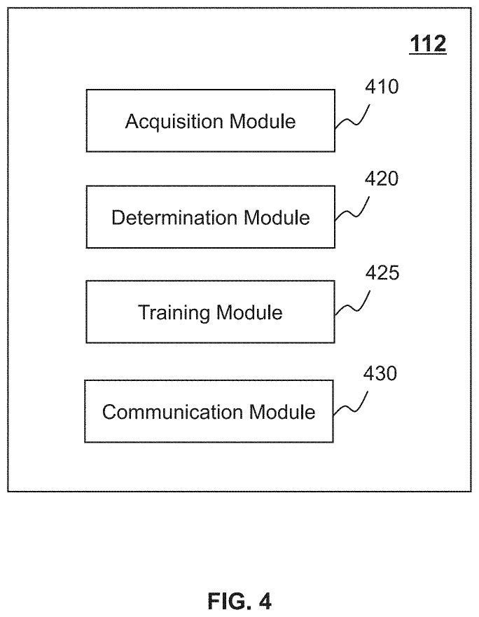

FIG. 4 is a block diagram illustrating an exemplary processing engine 112 according to some embodiments of the present disclosure. The processing engine 112 may include an acquisition module 410, a determination module 420, a training module 425, and a communication module 430.

The acquisition module 410 may be configured to obtain one or more service requests or example service orders. The acquisition module 410 may obtain a service request from a terminal (e.g., the requester terminal 130) via the network 120. In some embodiments, the acquisition module 410 may obtain the example service orders from a database (e.g., the database 150) via the network 120. Alternatively, the example service orders are obtained by the training module 425. In some embodiments, the example service orders may have one or more features in common with the service request. The acquisition module 410 may analyze the example service orders and extract information related to the example service orders (e.g., one or more features). Here, the term “feature” refers to any specific category of information or characteristics that are associated with the service request or the example service orders.

In some embodiments, the service request may be a request for a transportation service. The acquisition module 410 may analyze the service request and extract information related to the service request (e.g., a departure location, a start time, a destination, requestor information, requestor preferences, etc.). The service request may include information related to the requested trip, such as but not limited to departure location, pick-up time, current time, and/or destination. The service request may also include information associated with a requestor that has submitted the request for the transportation service (the requestor information). The information associated with the requestor may include profile information of the requestor, request preference of the requestor, or the like, or a combination thereof. The profile information of the requestor may include, for example, the name or nickname of the requestor, the age of the requestor, the gender of the requestor, the date of birth of the requestor, a city in which the requestor resides, or the like, or any combination thereof. The request preference may refer to the requester's requirements about the transportation service. For example, the requestor terminal 130 may determine one or more preference parameters (e.g., a vehicle type, a size of the trunk, a load of a vehicle) from the service request based on an input of the requestor or based on default settings. As another example, the request preference may include an indication about whether the requestor agrees to share the transportation service with other requesters in the service request (e.g., a carpool preference).

The acquisition module 410 may further obtain relevant information associated with the service request and/or the example service orders. For example, the acquisition module 410 may obtain traffic information (e.g., real-time and/or historical traffic congestion information, real-time and/or historical traffic control information, real-time and/or historical traffic barrier information, etc.) associated with the service request and/or example service orders. As another example, the acquisition module 410 may obtain real-time and/or historical weather information associated with the service request and/or the example service orders. As a further example, the acquisition module 410 may obtain one or more features of the service request and/or the example service orders.

The determination module 420 may be configured to determine an estimated basic fee of the service request, an estimated adjusting rate of fee associated with the service request, an estimated conversion rate of transaction associated with the service request, and/or any parameters associated with the service request.

In some embodiments, the determination module 420 may determine at least one route associated with the service request based on the departure location and the destination. In certain embodiments, the determination module 420 may also determine the at least one route further based on other information, such as the time of the request. The determination module 420 may further determine a target route from the at least one route and determine the estimated basic fee based on the target route. In some embodiments, the target route may be determined by system default or based on specific demands included in the service request. For example, the system default may determine the target route based on the shortest time required. In certain embodiments, however, a demand in the service request can override the system default and direct that the target route shall avoid any toll roads.

In some embodiments, the determination module 420 may determine the estimated adjusting rate of fee based on the relevant information (e.g., the traffic information, the weather information, the start time) associated with the service request, The adjusting rate of fee may affect the final price of the transportation service and it may also affect how likely a driver is likely to accept the service request.

As a further example, the determination module 420 may the estimated conversion rate of transaction with a prediction model. The conversion rate of transaction may reflect the likelihood that a driver will accept the price of the transaction, wherein the price depends on the basic fee and the adjusting rate. In some embodiments, the prediction model may be trained by data derived from example service orders, which include certain similar features as the service request being processed.

In some embodiments, the determination module 420 may further determine a target function relating to the estimated basic fee, the estimated adjusting rate of fee, and the estimated conversion rate of transaction. For example, the determination module 420 may determine a gross merchandise volume (GMV) of the service request based on the estimated basic fee, the adjusting rate of fee, and the conversion rate of transaction. In some embodiments, the GMV may equal the estimated basic fee times the adjusting rate of fee and further times the conversion rate of transaction. In certain embodiments, the GMV may reflect the value created by a single transaction. In certain embodiments, on a larger scale, the GMV may reflect the value created by a plurality of transactions based on a single platform. In certain embodiments, on an even larger scale, the GMV may reflect the value created by all the transaction based on a single platform within a preset time period. The determination module 420 may further determine an optimized adjusting rate of fee based on the target function.

In some embodiments, the training module 425 may obtain a plurality of example service orders and designate each of the example service orders with one or more labels and extract the one or more features from the plurality of example service orders. The training module 425 may further train the prediction model based on the one or more features and the plurality of designated example service orders. In certain embodiments, the training module 425 may be integrated into the acquisition module 410 and the determination module 420 and its functions may be performed by these modules.

The communication module 430 may be configured to send information associated with the service request to the requestor terminal (e.g., the requestor terminal 130). In some embodiments, the communication module 430 may send the estimated basic fee of the service request and/or the estimated adjusting rate of fee associated with the service request to the requestor terminal 130. In some embodiments, the communication module 430 may send the basic fee of the service request and/or the optimized adjusting rate of fee associated with the service request to the requestor terminal 130. For example, the communication module 430 may send an optimized fee to the requestor terminal 130, wherein the optimized fee is determined based on the optimized adjusting rate and the estimated basic fee. In some embodiments, the optimized fee may equal the optimized adjusting rate times the estimated basic fee. In some embodiments, the communication module 430 may send a notification associated with an abnormality to the requestor terminal 130. In some embodiments, the communication module 430 may send a bill of the service request to the requestor terminal 130 when the transportation service is finished.

In some embodiments, the communication module 430 may receive a response from the requestor terminal 130. The response may indicate whether the requestor has any questions about the transportation service, whether the requestor needs any help associated with service request, etc.

In some embodiments, upon receiving the response from the requestor terminal 130, the communication module 430 may transmit the response to the determination module 420, and further send a reply (e.g., a fee compensation) generated by the determination module 420 to the requestor terminal 130. For example, in response to receiving a request for disputing the estimated adjusting rate of fee, the communication module 430 may transmit the request for disputing the estimated adjusting rate of fee to the determination module 420, and further send an optimized adjusting rate of fee to the requestor terminal 130. As another example, in response to receiving a request for disputing the optimized adjusting rate of fee, the communication module 430 may transmit the request for disputing the optimized adjusting rate of fee to the determination module 420, and further send an amended optimized adjusting rate of fee to the requestor terminal 130.

In some embodiments, the information associated with the service request (e.g., the notification, the response, the reply) may be transmitted and/or received via a message using any suitable communication protocol (e.g., the Hypertext Transfer Protocol (HTTP), Address Resolution Protocol (ARP), Dynamic Host Configuration Protocol (DHCP), File Transfer Protocol (FTP)).

The modules in the processing engine 112 may be connected to or communicate with each other via a wired connection or a wireless connection, The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the acquisition module 410 may be integrated into the determination module 420 as a single module which may both obtain the service request and the example service orders and determine the estimated basic fee, the estimated adjusting rate of fee and/or the estimated conversion rate of transaction associated with the service request, As another example, the processing engine 112 may include a storage module (not shown in FIG. 4) which may be configured to store the service request, the example service orders, and/or the information associated with the service request.

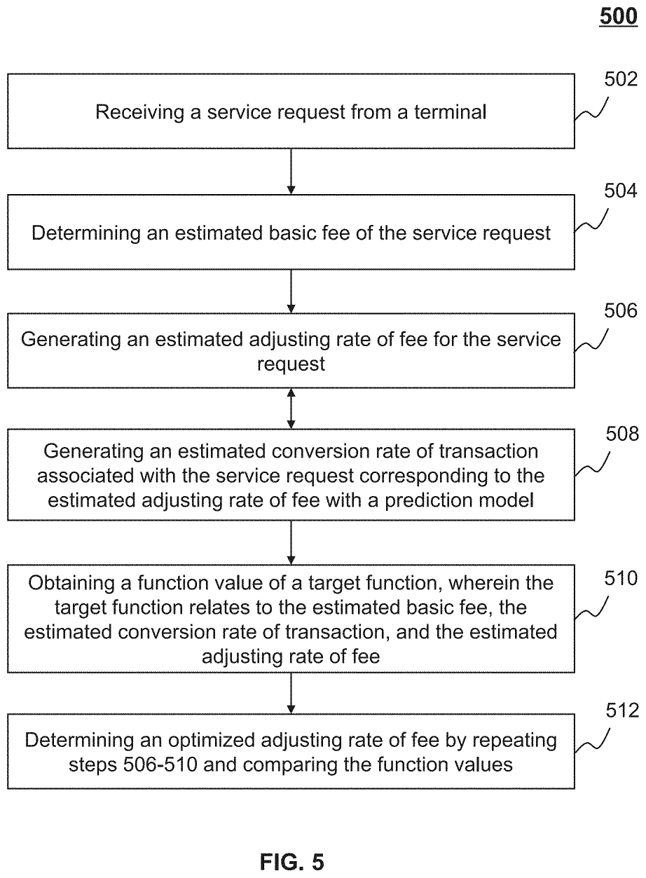

FIG. 5 is a flowchart illustrating an exemplary process 500 for determining a fee of a service request according to some embodiments of the present disclosure. The process 500 may be executed by the on-demand service system 100. For example, the process 500 may be implemented as a set of instructions (e.g., an application) stored in the storage ROM 230 or RAM 240. The CPU 220 may execute the set of instructions and may accordingly be directed to perform the process 500. The operations of the illustrated process presented below are intended to be illustrative. In some embodiments, the process may be accomplished with one or more additional operations not described, and/or without one or more of the operations discussed. Additionally, the order in which the operations of the process as illustrated in FIG. 5 and described below is not intended to be limiting.

In 502, the processing engine 112 may receive a service request from a terminal (e.g., the requestor terminal 130). The service request may include a departure location and a destination. As used herein, the departure location may refer to a location where a service provider may pick up the requestor. The destination may refer to a location where the service provider may drop off the requestor.

In some embodiments, the service request may be a request for a transportation service (e.g., a taxi service). The service request may include a real-time request, an appointment request, and/or any other request for one or more types of services. As used herein, the real-time request may indicate that the requestor wishes to use the transportation service at the present moment or at a defined time range with respect to the present moment. For example, a service request may be a real-time request if the defined time range is within a threshold value with respect to the present moment, i.e., 8:30 am, such as within 1 minute ahead of 8:30 am, within 5 minutes ahead of 8:30 am, 10 minutes, within 20 minutes ahead of 8:30 am, etc. The service request with an indicated start time beyond the defined time range may be classified as the appointment request. For example, a service request may be classified as an appointment request if the indicated start time is beyond the defined time range, i.e., beyond 20 minutes ahead of the present time, beyond 2 hours ahead of the present time, beyond 1 day ahead of the present time. In some embodiments, the processing engine 112 may define the real-time request or the appointment request based on a time threshold. The time threshold may be a default setting of the on-demand service system 100, or may be adjustable depending on different situations. For example, in a traffic peak period, the time threshold may be relatively small (e.g., 10 minutes), while in an idle period (e.g., 10:00-12:00 am), the time threshold may be relatively large (e.g., 1 hour).

In 504, the processing engine 112 may determine an estimated basic fee of the service request. In some embodiments, the processing engine 112 may determine at least one route based on the departure location and the destination. The processing engine 112 may further determine a target route from the at least one route based on at least one distance corresponding to the at least one route. For example, the processing engine 112 may identify the shortest distance from the at least one distance and select a candidate route associated with a shortest distance as the target route. In some embodiments, the processing engine 112 may determine the target route from the at least one route based on at least one traffic condition corresponding to the at least one route. As another example, the processing engine 112 may evaluate the at least one traffic condition associated with the at least one route and select a candidate route with a best traffic condition as the target route. In some embodiments, the processing engine 112 may determine the target route from the at least one route based on estimated travel time for each route. As another example, the processing engine 112 may select a candidate route with a shortest travel time as the target route. In some embodiments, the processing engine 112 may determine the target route from the at least one route based on estimated toll payment for each route. As another example, the processing engine 112 may select a candidate route with a lowest toll payment as the target route. In some embodiments, the processing engine 112 may determine a target route based on a function that depends on multiple factors, such as but not limited to distance, traffic condition, travel time, and toll payment, each having similar or different weight for determination of the target route. Further, the processing engine 112 may determine the estimated basic fee of the service request based on the target route.

In some embodiments, when determining the estimated basic fee of the service request, the processing engine 112 may also take environmental information (e.g., traffic information, weather information) into consideration. As used herein, the traffic information may include traffic congestion information, traffic control information, traffic barrier information, etc.

The processing engine 112 may obtain the traffic information from the database 150, a map service (e.g., a Google Map™, a Tencent Map™, a Baidu Map™), and/or any other service that can provide traffic information in a geographic area. For example, in response to receiving a real-time request, the processing engine 112 may obtain a departure location A and a destination B based on the real-time request. The processing engine 112 may access the database 150 to obtain real-time traffic status related to the departure location A, the destination B, and/or a recommended route from A to B. The processing engine 112 may further determine a reference time for a service provider to drive from A to B based on the real-time traffic status. As another example, in response to receiving an appointment request, the processing engine 112 may obtain a departure location C, a destination D, and a start time 8:00 p.m. on next Monday based on the appointment request. The processing engine 112 may access the database 150 to obtain historical traffic status of 8:00 p.m. from C to D in the past four Mondays and further determine a reference time for a service provider to drive a vehicle from C to D based on the historical traffic status.

In 506, the processing engine 112 may generate an estimated adjusting rate of fee for the service request. In some embodiments, the estimated adjusting rate of fee is generated by using a default value. For example, the initial estimated adjusting rate of fee can be set at 1.0, which may or may not be altered in subsequent steps. The default value may vary with certain information included in the service request. For example, for a certain time slot (e.g., peak traffic hours), the default value may be higher than 1.0 (e.g., 1.2, 1.3, etc.). In certain embodiments, the default value may be determined based on a function that takes into account information such as but not limited to: time slot, distance, traffic condition, weather, etc. In certain embodiments, the function may take into account the requestor's historical data, such as but not limited to the requestor's past service requesting records. For example, if the requester has made a large number of service requests and paid an amount that is higher than a threshold value in a preset period (e.g., the past 6 months), the default adjusting rate of fee may be set at a lower value.

In 508, the processing engine 112 may generate an estimated conversion rate of transaction corresponding to the estimated adjusting rate of fee associated with the service request with a prediction model. The estimated conversion rate of transaction may represent a possibility that the service request will be accepted by a service provider. In real-world scenarios for seeking a transportation service, the service request may not be accepted by a service provider (e.g., a driver) for a certain time period. For example, demand of the service request may exceed supply of the service providers during rush hour and some of the service request may not be timely accepted. With a higher adjusting rate of fee, the service providers have more incentive to accept the service request.

For example, when the estimated conversion rate of transaction associated with the service request is too low, the processing engine 112 may adjust the estimated adjusting rate of fee of the service request. The higher the estimated adjusting rate of fee of the service request, the greater the desire of the service providers to accept the service request. On the other hand, the higher the estimated adjusting rate of fee of the service request, the lower the possibility of the service requesters to agree with the adjusting rate.

In some embodiments, the processing engine 112 may choose the estimated adjusting rate of fee from a number of preset values (e.g., 1.0, 1.1, 1.2, 1.3, 1.4, 1.5) and adjust the estimated adjusting rate of fee by selecting a value that is different from the previous one. Each time, a corresponding conversion rate of transaction is determined. In certain embodiments, the repetition of steps 506 and 508 stops when the conversion rate is higher than a preset threshold value. The processing engine 112 may take into account all the pairs of estimated adjusting rates of fee and estimated conversion rates of transaction and proceed to step 510 to obtain function values of a target function.

In some embodiments, the processing engine 112 may generate a pair of estimated adjusting rates of fee and estimated conversion rates of transaction in each iteration of steps 506-510. For example, in each iteration, the estimated adjusting rate may be updated by a predetermined increment value in step 506. Then the estimated conversion rate of transaction may be updated in 508 accordingly. The pair of estimated adjusting rate of fee and estimated conversion rate may be processed in step 510. The predetermined increment value may be, for example, 0.05, 0.1, 0.15, 0.2, etc.

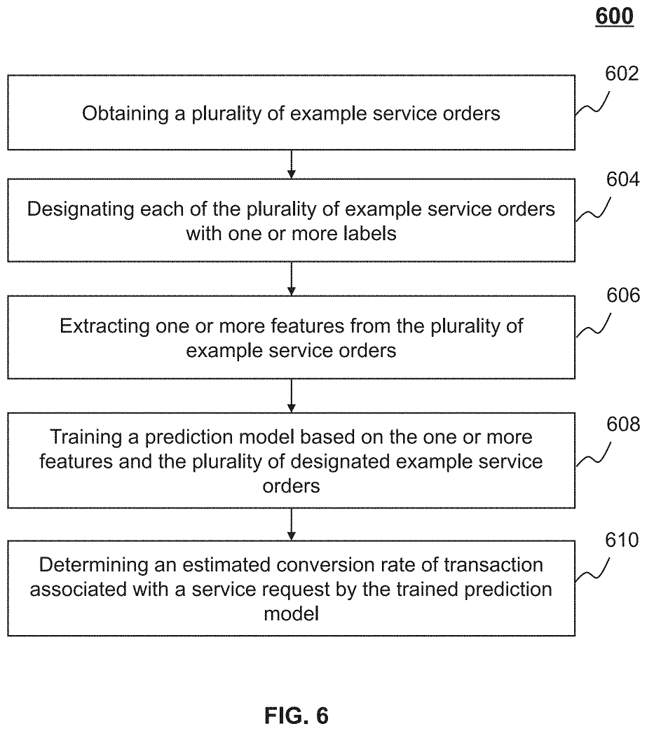

As indicated, a prediction model is used to determine the conversion rate of transaction. The prediction model is provided by training with data from example service orders, as shown in FIG. 6 and the associated description.

In 510, the processing engine 112 may obtain a function value of a target function. In some embodiments, the target function may relate to the estimated basic fee, the estimated conversion rate of transaction, and the estimated adjusting rate of fee. The target function may be a linear function, a quadratic function, a cubic function, a trigonometric function, an exponential function, a logarithms function, or the like, or any combination thereof. Merely by way of example, the processing engine 112 may determine the target function for calculating gross merchandise volume (GMV) according to formula (1) shown below:

Fₜ=F_{b}×Rₐ×R_{c} (1)

where Fₜ may refer to a value of the target function; F_{b} may refer to the estimated basic fee of the service request; Rₐ may refer to the estimated adjusting rate of fee; and R_{c} may refer to the estimated conversion rate of transaction corresponding to the estimated adjusting rate of fee.

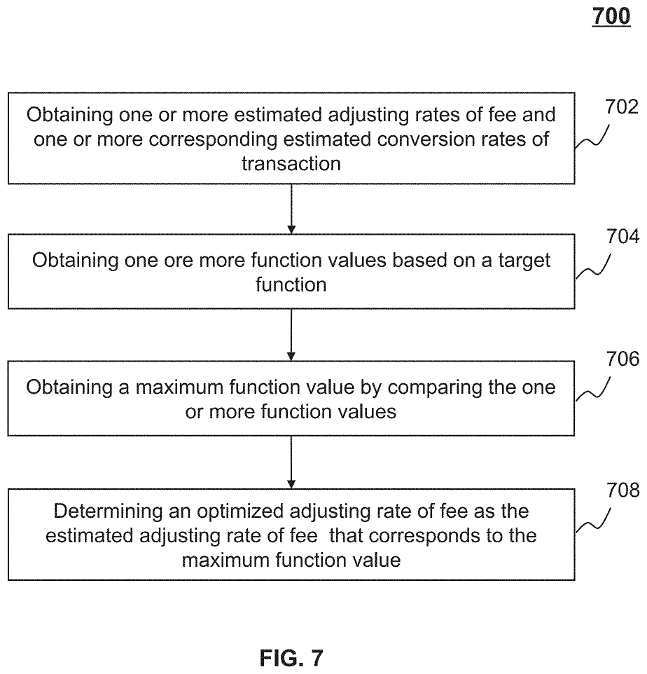

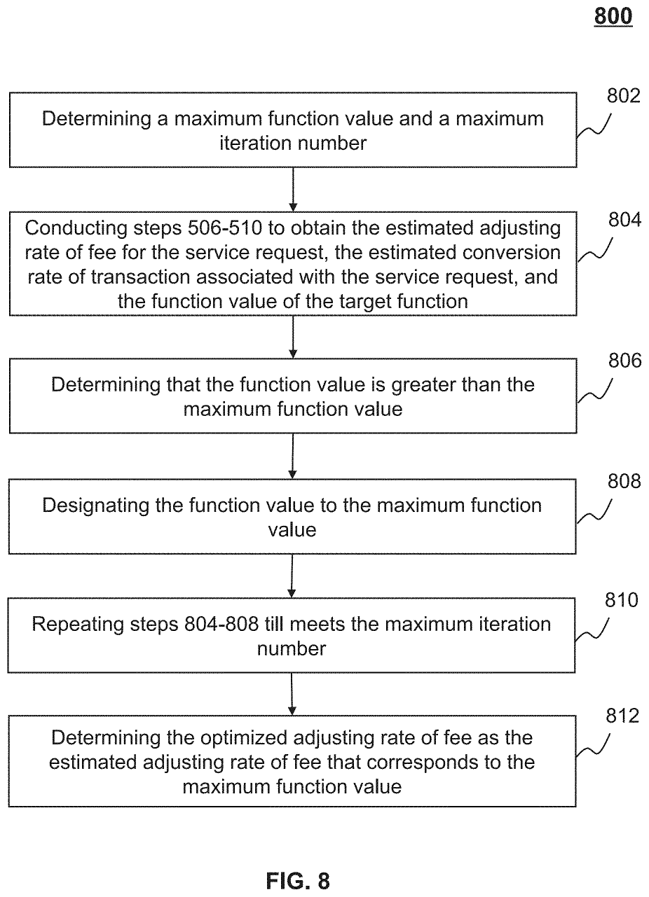

In 512, the processing engine 112 may determine an optimized adjusting rate of fee by repeating steps 506-510 and comparing the function values. The estimated conversion rate of transaction may vary with the estimated adjusting rate of fee. In some embodiments, the processing engine 112 may generate one or more estimated conversion rates of transaction associated with the service request corresponding to the one or more estimated adjusting rates of fee. Further, the processing engine 112 may determine one or more function values based on the target function. In some embodiments, the processing engine 112 may determine the optimized adjusting rate of fee as the estimated adjusting rate of fee that maximizes the function value. Detailed descriptions of determining the estimated adjusting rate may refer to elsewhere in the present disclosure. See, for example, FIG. 7 or 8.

In some embodiments, formula (1) may reflect the value of one transaction related to one service request. Such an approach may maximize the value of the service being requested, taking into account the basic service value (i.e., the estimated basic fee), factors that may affect the basic service value (i.e., the adjusting rate of fee, which reflects the influence of multiple factors such as but not limited to the time slot, the traffic condition, the weather, etc.), and the likelihood that the transaction will be completed (i.e., the conversion rate of transaction).

In some other embodiments, the target function may reflect not the value of an individual transaction, but the aggregated value of multiple transactions (e.g., all the services being requested in a limited area at a certain time) on a platform. For example, the target function may take into account the effects of a single service request (and its basic fee, adjusting rate of fee, and conversion rate of transaction) on the overall GMV related to service requests in an area (e.g. in a 1 km radius). Due to geographic proximity and closeness of time, certain service requests may affect one another. For instance, when the number of service requests exceeds the number of service providers in an area at a particular time, the improvement of the likelihood of one service request to get accepted may reduce the likelihood of another service request to be accepted. In some embodiments, the target function may reflect this overall value for multiple service requests and the processing engine 112 may determine the optimized adjusting rate of fee for a service request not as the estimated adjusting rate of fee that maximizes the value of formula (1), but the estimated adjusting rate of fee that maximizes the value of all the service requests in the area at the time. Therefore, under such circumstances, it would be possible that the optimized adjusting rate of fee according to formula (1) would be different from the optimized adjusting rate of fee for this service request based on all the service requests.

In some embodiments, the communication module 430 may send certain processed information (e.g., the estimated basic fee, the optimized adjusting rate of fee) to the requester terminal 130. In some embodiments, the received information (e.g., the estimated basic fee, the optimized adjusting rate of fee) associated with the service request may be presented with the service request on the requestor terminal 130 in a format of text, image, video content, audio content, graphics, or the like, or any combination thereof. For example, the information associated with the service request may be presented on one or more user interfaces of the requestor terminal 130.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., storing steps for storing the estimated basic fee, the at least one estimated adjusting rate of fee, the at least one estimated conversion rate of transaction) may be added elsewhere in the exemplary process 500. As another example, step 506 and 508 may be reversible. Firstly, the processing engine 112 may generate the estimated conversion rate of transaction. Then, the processing engine 112 may generate the estimated adjusting rate of fee corresponding to the estimated conversion rate of transaction.

FIG. 6 is a flowchart illustrating an exemplary process 600 for determining an estimated conversion rate of transaction of a service request with a prediction model according to some embodiments of the present disclosure. In essence, the process 600 can be used to obtain the prediction model in 508. In some embodiments, the process 600 may take place after receiving the service request is received and each prediction model is specifically tailored to facilitate the processing of the service request. In some embodiments, the process 600 may take place before the service request is received and a number of prediction models can be prepared for various types of service requests. In some embodiments, some steps of process 600 may be conducted before receiving the service request and some other steps are conducted after receiving the service request.

The process 600 may be executed by the on-demand service system 100. For example, the process and/or method 600 may be implemented as a set of instructions (e.g., an application) stored in the storage ROM 230 or RAM 240. The CPU 220 may execute the set of instructions and may accordingly be directed to perform the process 600. The operations of the illustrated process presented below are intended to be illustrative, In some embodiments, the process may be accomplished with one or more additional operations not described, and/or without one or more of the operations discussed. Additionally, the order in which the operations of the process as illustrated in FIG. 6 and described below is not intended to be limiting,

In 602, the processing engine 112 may obtain a plurality of example service orders. In some embodiments, the example service orders are historical service requests that may or may not have been completed. The plurality of example service orders may include one or more features. Such features include but are not limited to: starting location, destination, starting time (or time slot such peak hours or non-peak hours), basic fee, tip, adjusting rate, number of service orders from nearby area, number of service providers in nearby area, weather, accepting rate, and/or conversion rate of transaction. In some embodiments, all such features are historical data. In some embodiments, the processing engine 112 may obtain the plurality of example service orders from a database (e.g., the database 150). In some embodiments, the example service orders can be divided into two groups: one group is used to train the prediction model and the other group is used to test the prediction model to determine whether the training should be stopped. For example, in certain embodiments, the ratio between the number of service orders from the training group and the testing group may be 5:5, 6:4, 7:3, 8:2 or 9:1. In certain embodiments, the ratio between the number of service orders from the training group and the testing group is 7:3. In some embodiments, the example service orders may be selected based on certain conditions. For example, the processing engine 112 may select the example service orders that were made within a certain time period (e.g., in June 2017), or within a time period that is close to the present (e.g., within the past three months).

In 604, the processing engine 112 may designate each of the plurality of example service orders with one or more labels. The one or more labels may be used to classify the plurality of example service orders. In some embodiments, the processing engine 112 may designate each of the plurality of example service orders with two labels. For example, fulfilled example service orders may be labeled with 1 and unfulfilled example service orders may be labeled with 0.

In 606, the processing engine 112 may extract the one or more features from the plurality of example service orders. For example, the one or more features may include basic characteristics of the service request, real-time characteristics of the service request, historical characteristics of a service order, or the like, or any combination thereof. The basic characteristics of the service request may include the departure location, the destination, a tip, or the like, or any combination thereof. The real-time characteristics of the service request may include weather, traffic conditions, a time of the service request, a quantity of surrounding service requests, a quantity and distance of surrounding drivers, an adjusting rate of the service request, or the like, or any combination thereof. The historical characteristics of the service order may include an estimated fee of the service order, a snatching rate of the service order, a conversion rate of transaction associated with the service order, or the like, or any combination thereof.

In 608, the processing engine 112 may train a prediction model based on the one or more features and the plurality of designated example service orders from the training group. The processing engine 112 may input the one or more features and the plurality of designated example service orders into the prediction model and the prediction model may output a plurality of conversion rates of transaction corresponding to the plurality of example service orders. In some embodiments, the processing engine 112 may compare the plurality of conversion rates of transaction with the conversion rates of transaction associated with the plurality of example service orders from the training group to refine the training. Further, the processing engine 112 may test the accuracy of the prediction model. In some embodiments, the features from one or more of the example service orders of the testing group may be used to test whether the prediction model can provide an accurate prediction as to whether the service orders are fulfilled (e.g., predicting the conversion rate of transaction). The processing engine 112 may stop training the prediction model when the accuracy of the prediction model is higher than a threshold; otherwise, the processing engine 112 may correct, optimize, or retrain the prediction model continually. The threshold may be default settings of the on-demand service system 100 (e.g., 80%, 90%), or may be adjustable based on an instruction from a user. In some embodiments, the prediction model may include an Extreme Gradient Boosting (Xgboost) model, a decision tree model, a Gradient Boosting Decision Tree (GBDT) model, a linear regression model, a neural network model, a deep learning model, or the like, or any combination thereof.

In 610, the processing engine 112 may determine an estimated conversion rate of transaction associated with a service request by the trained prediction model. In some embodiments, the processing engine 112 may input the one or more features associated with the service request into the trained prediction model. The prediction model may output the estimated conversion rate of transaction associated with the service request. The one or more features of the service request may include a departure location, a destination, a tip, weather, a time of the service request, a quantity of surrounding service requests, a quantity and distance of surrounding drivers, an adjusting rate of fee, or the like, or any combination thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., storing steps for storing the example service orders and the service request) may be added elsewhere in the exemplary process 600. As another example, step 604 and 606 may be reversible.

Additional details and variations that are related to the embodiments shown in FIG. 6 may also be part of the present invention. In some embodiments, the plurality of example service orders may be selected according to some features of the service request. For example, after obtaining certain features (e.g., the time slot, the starting location, the destination, the region, and/or the distance) of the service request, the processing engine 112 may select a plurality of example service orders having similar features (as shown in 602) and proceed to designate the service orders, train the prediction model, test the accuracy or the prediction model, and determine the estimated conversion rate of transaction for the service request based on the trained prediction model.

In some other embodiments, the processing engine 112 may pre-train a number of prediction models and chose the appropriate model to obtain the results. For example, the processing engine 112 may classify a larger number of example service orders (e.g. from a database of historical data) into categories, each of which includes a plurality of example service orders having similar features (e.g., the time slot, the starting location, the destination, the region, and/or the distance). Then the processing engine 112 may train the prediction model with example service orders from each category and also test the accuracy of the prediction model. By doing so, the processing engine 112 may prepare a number of trained prediction models that can be used when a new service request comes. In some embodiments, the trained prediction models can be updated periodically with new data.

FIG. 7 is a flowchart illustrating an exemplary process 700 for determining an optimized adjusting rate of fee based on a target function according to some embodiments of the present disclosure. The process 700 may be executed by the on-demand service system 100. For example, the process 700 may be implemented as a set of instructions (e.g., an application) stored in the storage ROM 230 or RAM 240. The CPU 220 may execute the set of instructions and may accordingly be directed to perform the process 700. The operations of the illustrated process presented below are intended to be illustrative. In some embodiments, the process may be accomplished with one or more additional operations not described, and/or without one or more of the operations discussed. Additionally, the order in which the operations of the process 700 as illustrated in FIG. 7 and described below is not intended to be limiting.

In 702, the processing engine 112 may obtain one or more estimated adjusting rates of fee and one or more corresponding estimated conversion rates of transaction. In some embodiments, the processing engine 112 may obtain the one or more estimated adjusting rates of fee from the estimated adjusting rate of fee generated in 506. The processing engine 112 may obtain the one or more corresponding estimated conversion rates of transaction from the estimated conversion rates of transaction generated in step 508.

In 704, the processing engine 112 may obtain one or more function values based on a target function. The processing engine 112 may obtain the one or more function values by utilizing the one or more estimated adjusting rates of fee and the one or more corresponding estimated conversion rates of transaction. In some embodiments, the processing engine 112 may obtain the one or more function values according to formula (1).

In 706, the processing engine 112 may obtain a maximum function value by comparing the one or more function values. For example, the processing engine 112 may choose the maximum values from the function values generated in step 706.

In 708, the processing engine 112 may determine an optimized adjusting rate of fee as the estimated adjusting rate of fee maximize the function value. The one or more estimated adjusting rates of fee may correspond to the one or more function values. The processing engine 112 may determine the optimized adjusting rate of fee based on the estimated adjusting rate of fee corresponding to a maximum function value.

As indicated in the descriptions for the process 500, there are details and variations for determining the optimized adjust rate of fee that are also considered embodiments of the present invention. For example, the function for determining the optimized adjusting rate of fee may be different from formula (1). In some embodiments, the optimized adjusting rate of fee may be determined as the adjusting rate of fee that helps to maximize the function value (e.g. GMV) of the total value of all transactions in a limited area in a certain time slot, not the adjusting rate of fee that maximize the function value of the single transaction related to service request.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., storing steps for storing the one or more estimated adjusting rates of fee, the one or more corresponding estimated conversion rate of transaction, and/or one or more function value) may be added elsewhere in the exemplary process 700.

FIG. 8 is a flowchart illustrating an exemplary process 800 for determining an optimized adjusting rate of fee based on a target function according to some embodiments of the present disclosure. The process 800 may be executed by the on-demand service system 100. For example, the process 800 may be implemented as a set of instructions (e.g., an application) stored in the storage ROM 230 or RAM 240. The CPU 220 may execute the set of instructions and may accordingly be directed to perform the process 800. The operations of the illustrated process presented below are intended to be illustrative. In some embodiments, the process may be accomplished with one or more additional operations not described, and/or without one or more of the operations discussed. Additionally, the order in which the operations of the process 800 as illustrated in FIG. 8 and described below is not intended to be limiting.

In 802, the processing engine 112 may determine a maximum function value and a maximum iteration number. The maximum function value may be an initial value of the target function as described FIG. 5 to start a first iteration. The maximum function value may be designated with any value by a user or by default, for example, any negative number, zero, a suitable positive number, etc. The maximum iteration number may indicate the iteration times of the process 800. The maximum iteration number may be designated with any value by a user or by default, for example, 10 times, 50 times, 100 times, 150 times, etc.

In 804, the processing engine 112 may conduct steps 506-510 as described in FIG. 5 to obtain the estimated adjusting rate of fee for the service request, the estimated conversion rate of transaction associated with the service request, and the function value of the target function. Detailed description of step 804 may refer to the description of steps 506-510 in FIG. 5.

In 806, the processing engine 112 may judge whether the function value obtained in 804 is greater than the maximum function value determined in 802 or not. If the function value is no greater than the maximum function value, the maximum may stay the same value and the process 800 may proceed to step 810. If the function value is greater than the maximum function value, the maximum function value may be designated or updated with the function value in step 808, and the process 800 may proceed to step 810.

In 810, the processing engine 112 may judge whether the iteration count of iteration times meets the maximum iteration number or not. If the iteration count is less than the maximum iteration number, the process 800 may repeat steps 804-808 again. For example, the estimated adjusting rate of fee may be updated by a predetermined increment value in step 506. Then the estimated conversion rate of transaction and the function value of the target function may be obtained according in steps 508 and 510. The predetermined increment value may be, for example, 0.05, 0.1, 0,15, 0.2, etc. If the iteration count equals to the maximum iteration number, the process 800 may proceed to step 812.

In 812, the processing engine 112 may determine the optimized adjusting rate of fee as the estimated adjusting rate of fee that corresponds to the maximum function value. For example, after steps 810, the maximum function value may be updated through a plurality of times. The processing engine 112 may select the estimated adjusting rate that corresponds to the maximum function value as the optimized adjusting rate of fee. In some embodiments, there may be two or more estimated adjusting rates of fee that correspond to the maximum function value, the processing engine 112 may determine, for example, a minimum value of the two or more estimated adjusting rates of fee as the optimized adjusting rate of fee.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., storing steps for storing the estimated adjusting rate of fee, the corresponding estimated conversion rate of transaction, and/or the function value) may be added elsewhere in the exemplary process 800.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed,

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system,” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, radiofrequency (RF), or the like, or any suitable combination of the foregoing.

Computer program code for carrying out operations for aspects of the present disclosure may be written in any combination of one or more programming languages, including an object-oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
at least one storage medium including a set of instructions for determining a fee of a service request in an on-demand service; and
at least one processor configured to communicate with the at least one storage medium, wherein when executing the set of instructions, the at least one processor is directed to detect an application executing on a terminal, and:
(a) receive a service request from the terminal, the service request being sent by a user through the application executing on the terminal;
(b) determine an estimated basic fee of the service request;
(c) generate an estimated adjusting rate of fee for the service request;
(d) generate an estimated conversion rate of transaction associated with the service request based on the estimated adjusting rate of fee with a prediction model;
(e) obtain a function value of a target function, wherein the target function relates to the estimated basic fee, the estimated conversion rate of transaction, and the estimated adjusting rate of fee; and
(f) determine an optimized adjusting rate of fee by repeating steps (c)-(e) and comparing the function values, wherein the optimized adjusting rate of fee maximizes the function value of the target function; and
(g) send the optimized adjusting rate of fee to the terminal to be presented on an interface of the terminal.

2. The system of claim 1, wherein the target function is for calculation of gross merchandise volume (GMV) by multiplying the estimated basic fee of the service request, the estimated adjusting rate of fee associated with the service request, and the estimated conversion rate of transaction associated with the service request together.

3. The system of claim 1, wherein to determine the estimated basic fee of the service request, the at least one processor is directed to:
determine at least one route associated with the service request;
determine a target route from the at least one route; and
determine the estimated basic fee of the service request based on the target route.

4. The system of claim 1, wherein to determine the estimated conversion rate of transaction associated with the service request based on the estimated adjusting rate with the prediction model, the at least one processor is directed to:
obtain a plurality of example service orders;
designate each of the plurality of example service orders with one of one or more labels;
extract one or more features from the plurality of example service orders, wherein the service request also includes the one or more features;
train the prediction model based on the one or more features and the plurality of designated example service orders; and
determine the estimated conversion rate of transaction associated with the service request based on the estimated adjusting rate with the trained prediction model.

5. The system of claim 3, wherein the one or more features include at least one of basic characteristics of the service request, real-time characteristics of the service request, and historical characteristics of a service order.

6. The system of claim 1, wherein to determine the optimized adjusting rate of fee by repeating steps (c)-(e) and comparing the function values, the at least one processor is directed to:
obtain a plurality of the estimated adjusting rates of fee and a plurality of the estimated conversion rates of transaction;
obtain a plurality of the function values based on the target function, utilizing the a plurality of the estimated adjusting rates of fee and the a plurality of the estimated conversion rates of transaction;
obtain a maximum function value by comparing the a plurality of the function values; and
determine the optimized adjusting rate of fee as the estimated adjusting rate that corresponds to the maximum function value.

7. The system of claim 1, wherein to determine the optimized adjusting rate of fee by repeating steps (c)-(e) and comparing the function values, the at least one processor is directed to:
(1) determine a maximum function value and a maximum iteration number;
(2) conduct steps (c)-(e) to obtain the estimated adjusting rate of fee for the service request, the estimated conversion rate of transaction associated with the service request, and the function value of the target function;
(3) determine that the function value is greater than the maximum function value;
(4) designate the function value in (3) as the maximum function value;
(5) repeat steps (2)-(4) till meets the maximum iteration number; and
(6) determine the optimized adjusting rate of fee as the estimated adjusting rate of fee that corresponds to the maximum function value.

8. The system of claim 7, wherein the estimated adjusting rate of fee associated with the service request is restricted by a first threshold, or the estimated conversion rate of transaction associated with the service request is restricted by a second threshold.

9. The system of claim 1, wherein the estimated adjusting rate of fee is selected from a limited number of preset values.

10. The system of claim 9, where to determine the optimized adjusting rate of fee by repeating steps (c)-(e) and comparing the function values, the at least one processor is directed to:
repeat steps (c)-(e) for a limited number of times:
each time in step (c), reset the estimated adjusting rate of fee to a new value from the limited number of preset values;
each time in step (d) generate the estimated conversion rate of transaction based on the estimated adjusting rate of fee; and
each time in step (e) obtain the function value of a target function; and
conduct step (f) to determine the optimized adjusting rate of fee as the estimated adjusting rate of fee that maximize a function value of the target function. 11, (Original) A method, comprising:
(a) receiving a service request from a terminal;
(b) determining an estimated basic fee of the service request;
(c) generating an estimated adjusting rate of fee for the service request corresponding to the estimated conversion rate of transaction;
(d) generating an estimated conversion rate of transaction associated with the service request based on the estimated adjusting rate of fee with a prediction model;
(e) obtaining a function value of a target function, wherein the target function relates to the estimated basic fee, the estimated conversion rate of transaction, and the estimated adjusting rate of fee; and
(f) determining an optimized adjusting rate of fee by repeating steps (c)-(e) and comparing the function values, wherein the optimized adjusting rate of fee maximizes the function value of the target function.

12. The method of claim 11, wherein the target function is for calculation of gross merchandise volume (GMV) by multiplying the estimated basic fee of the service request, the estimated adjusting rate of fee associated with the service request, and the estimated conversion rate of transaction associated with the service request together.

13. The method of claim 11, wherein the determining the estimated basic fee of the service request further comprises:
determining at least one route associated with the service request;
determining a target route from the at least one route; and
determining the estimated basic fee of the service request based on the target route.

14. The method of claim 11, wherein the determining the estimated conversion rate of transaction associated with the service request based on the estimated adjusting rate with the prediction model further comprises:
obtaining a plurality of example service orders;
designating each of the plurality of example service orders with one of one or more labels;
extracting one or more features from the plurality of example service orders, wherein the service request also includes the one or more features;
training the prediction model based on the one or more features and the plurality of designated example service orders; and
determining the estimated conversion rate of transaction associated with the service request based on the estimated adjusting rate with the trained prediction model.

15. The method of claim 13, wherein the one or more features include at least one of basic characteristics of the service request, real-time characteristics of the service request, and historical characteristics of a service order.

16. The method of claim 11, wherein the determining the optimized adjusting rate of fee by repeating steps (c)-(e) and comparing the function values further comprises:
obtaining one or more estimated adjusting rates of fee and one or more corresponding estimated conversion rates of transaction;
obtaining one or more function values based on the target function, utilizing the one or more estimated adjusting rates of fee and the one or more corresponding estimated conversion rates of transaction;
obtaining a maximum function value by comparing the one or more function values, and
determining the optimized adjusting rate of fee as the estimated adjusting rate that corresponds to the maximum function value.

17. The method of claim 11, wherein the determining the optimized adjusting rate of fee by repeating steps (c)-(e) and comparing the function values further comprises:
(1) determining a maximum function value and a maximum iteration number;
(2) conducting steps (c)-(e) to obtain the estimated adjusting rate of fee for the service request, the estimated conversion rate of transaction associated with the service request, and the function value of the target function;
(3) determining that the function value is greater than the maximum function value;
(4) designating the function value to the maximum function value;
(5) repeating steps (2)-(4) till meets the maximum iteration number; and
(6) determining the optimized adjusting rate of fee as the estimated adjusting rate of fee that corresponds to the maximum function value.

18. The method of claim 17, wherein the estimated adjusting rate of fee associated with the service request is restricted by a first threshold, or the estimated conversion rate of transaction associated with the service request is restricted by a second threshold.

19. The method of claim 11, wherein the estimated adjusting rate of fee is selected from a limited number of preset values.

20. A non-transitory computer readable medium embodying a computer program product, the computer program product comprising instructions configured to cause a computing device to:
(a) receive a service request from a terminal;
(b) determine an estimated basic fee of the service request;
(c) generate an estimated adjusting rate of fee for the service request corresponding to the estimated conversion rate of transaction;
(d) generate an estimated conversion rate of transaction associated with the service request based on the estimated adjusting rate of fee with a prediction model;
(e) obtain a function value of a target function, wherein the target function relates to the estimated basic fee, the estimated conversion rate of transaction, and the estimated adjusting rate of fee; and
(f) determine an optimized adjusting rate of fee by repeating steps (c)-(e) and comparing the function values, wherein the optimized adjusting rate of fee maximizes the function value of the target function.
